(19) United States
(12) Patent Application Publication
(10) Pub. No.: US 2005/0001944 A1
(43) Pub. Date: Jan. 6, 2005

(54) Method of stabilizing parasitic capacitance in an LCD device

(76) Inventors: Ching-Hung Wu, Sinshe Township (TW); Ruei-Pei Chen, Jhonghe City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/747,744

(22) Filed: Dec. 29, 2003

(30) Foreign Application Priority Data
Jun. 5, 2003 (TW) 92115187

(51) Int. Cl. G02F 1/136

(52) U.S. Cl. 349/44

(57) ABSTRACT

A method of stabilizing parasitic capacitance in an LCD device. Pluralities of transversely expanding gate lines are formed on a substrate. A first insulating layer is formed on the substrate and the gate lines. By performing a photolithography procedure using a photomask, a plurality of longitudinally expanding data lines and a plurality of metallic light shield layers are formed on part of the first insulating layer, wherein the metallic light shield layers are located on both sides of the data line. A second insulating layer is formed on the metallic light shield layers and the data lines. Transparent conductive layers are formed on part of the second insulating layer. Moreover, conductive plugs penetrating the second insulating layer are formed to electrically connect the metallic light shield layers and the transparent conductive layers.

### BACKGROUND OF THE INVENTION

1. Field of the Invention

The present invention relates to a method of forming a liquid crystal display (LCD) device, and more particularly, to a method of forming an LCD device which stabilizes parasitic capacitance caused by light shield film.

2. Description of the Related Art

Liquid crystal display (LCD) devices are widely used as displays in devices, such as portable televisions and notebook computers. The LCD device includes a plurality of pixel cells, each including a switching thin film transistor (TFT). In order to improve display quality, striped type light shield layers are usually formed around each pixel cell. Typically, the light shield layers are composed of metal.

FIG. 1 is a partial plane view of a conventional LCD device, showing light shield films formed around each pixel cell. FIG. 2 is a sectional view taken along line A-A′ of FIG. 1.

In FIGS. 1 and 2, by performing a first photolithography procedure using a first photomask, a plurality of transversely expanding gate lines 110 and floating light shield layers 120 are formed on a glass substrate 100. The gate line 110 has a protruding portion 115 serving as a gate 115. Then, a first insulating layer 130 is formed over the gate line 110 and the light shield layer 120.

By performing a second photolithography procedure using a second photomask, a semiconductor layer 140 is then formed on part of the first insulating layer 130. The semiconductor layer 140 can be a silicon layer.

By performing a third photolithography procedure using a third photomask, a source electrode 150, a drain electrode 152 and a plurality of longitudinally expanding data lines 153 are formed on the first insulating layer 130. The semiconductor layer 140 serves as a channel layer between the source electrode 150 and the drain electrode 152. The drain electrode 152 also electrically connects the data line 153, and the light shield layer 120 is located below both sides of the data line 153. A second insulating layer 160 is then formed on the source electrode 150, the drain electrode 152, the data lines 153 and the first insulating layer 130.

Next, by performing a fourth photolithography procedure using a fourth photomask, a pixel electrode 170 is formed on part of the second insulating layer 160 and electrically connects the source electrode 150. The pixel electrode 170 can be an ITO (indium tin oxide) layer.

Nevertheless, the conventional LCD process has several problems. The light shield layer 120, the data line 153, and the pixel electrode 170 are formed on different levels, thereby causing three parasitic capacitances to exist therebetween. That is, the light shield layer 120 and the data line 153 generate a first parasitic capacitance. The data line 153 and the pixel electrode 170 generate a second parasitic capacitance. The pixel electrode 170 and the light shield layer 120 generate a third parasitic capacitance. Moreover, a misalignment phenomenon easily occurs since the light shield layer 120 and the data line 153 are defined by different photomasks (or photolithography procedures). This misalignment causes the distance between the light shield layer 120 and the data line 153 to be dissimilar in each pixel cell, resulting in different parasitic capacitance in respective pixels. The unsettled parasitic capacitance seriously affects display quality, such as showing a stain or a Mura on screen. Moreover, each liquid crystal display panel is divided into several regions to be patterned, thereby worsening the misalignment problem.

In U.S. Pat. No. 5,745,194, Nakashima et al disclose an LCD device with a compensating capacitor. A capacitance film is formed between a pixel electrode and an adjacent data line to provide compensated capacitance. The compensator capacitance can compensate pixel voltage fluctuation resulting from an increase of parasitic capacitance caused by the light shield film. The method, however, utilizes different photomasks (or photolithography procedures) to form the capacitance film and the data line. Thus, the method is still subject to the misalignment problem.

### SUMMARY OF THE INVENTION

An object of the present invention is to provide a method of forming a liquid crystal display device with improved display quality.

Another object of the present invention is to provide a method of forming a liquid crystal device, which stabilizes parasitic capacitance caused by the light shield film.

In order to achieve these objects, the present invention provides a method of stabilizing parasitic capacitance in an LCD device. A glass substrate is provided. Pluralities of transversely expanding gate lines are formed on the glass substrate. A first silicon oxide (SiOₓ) layer is formed on the glass substrate and the gate lines. By performing a photolithography procedure using a photomask, a plurality of longitudinally expanding data lines and a plurality of metallic light shield layers are formed on part of the first silicon oxide layer, wherein the metallic light shield layers are located on the both sides of the data line. A second silicon oxide (SiOₓ) layer is formed on the metallic light shield layers and the data lines. Conductive plugs are formed to penetrate the second silicon oxide layer. Transparent conductive layers are formed on part of the second silicon oxide layer, wherein the metallic light shield layers electrically connect the transparent conductive layers by means of the conductive plugs.

The present invention improves on the prior art in that the data lines and the metallic light shield layers are defined on the first silicon oxide layer in the same photolithography procedure. Thus, there is a constant distance between the metallic light shield layer and the data line in each pixel cell. Moreover, the metallic light shield layer can electrically connect the transparent conductive layer by means of the conductive plug. According to the present method, the misalignment can be avoided and the metallic light shield layer and the transparent conductive layer are equipotential, thereby stabilizing parasitic capacitance in LCDs, improving display quality and ameliorating the disadvantages of the prior art.

### BRIEF DESCRIPTION OF THE DRAWINGS

The present invention can be more fully understood by reading the subsequent detailed description in conjunction with the examples and references made to the accompanying drawings, wherein:

FIG. 1 is a plane view of a conventional LCD device;

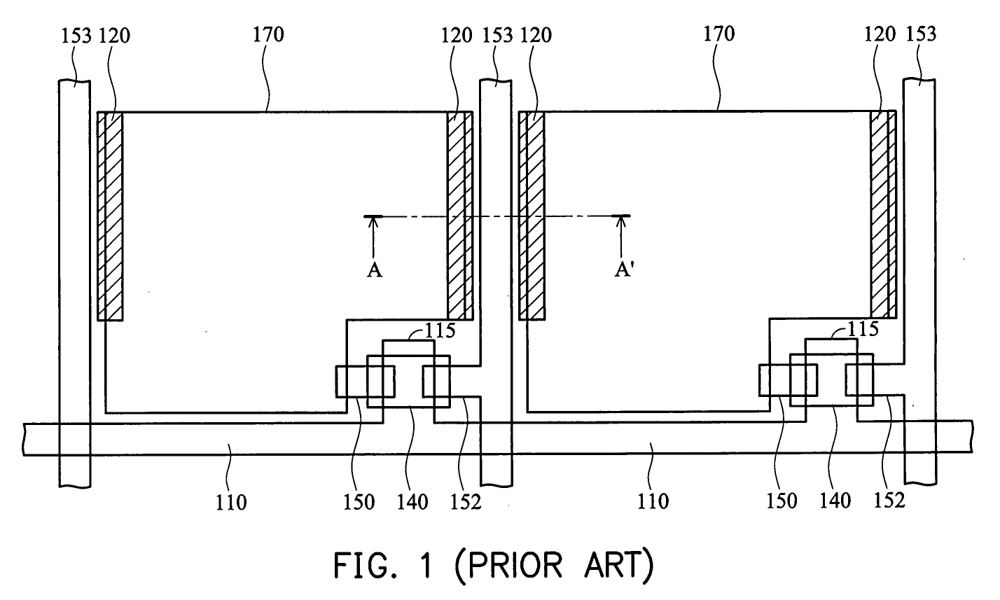

FIG. 2 is a sectional view taken along line A-A′ of FIG. 1;

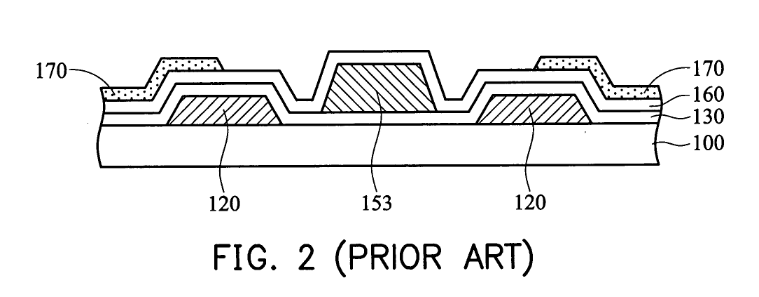

FIG. 3 is a plane view of an LCD device of the present invention; and

FIG. 4 is a sectional view taken along line B-B′ of FIG. 3.

### DETAILED DESCRIPTION OF THE INVENTION

Reference will now be made in detail to the present preferred embodiments of the invention, examples of which are illustrated in the accompanying drawings.

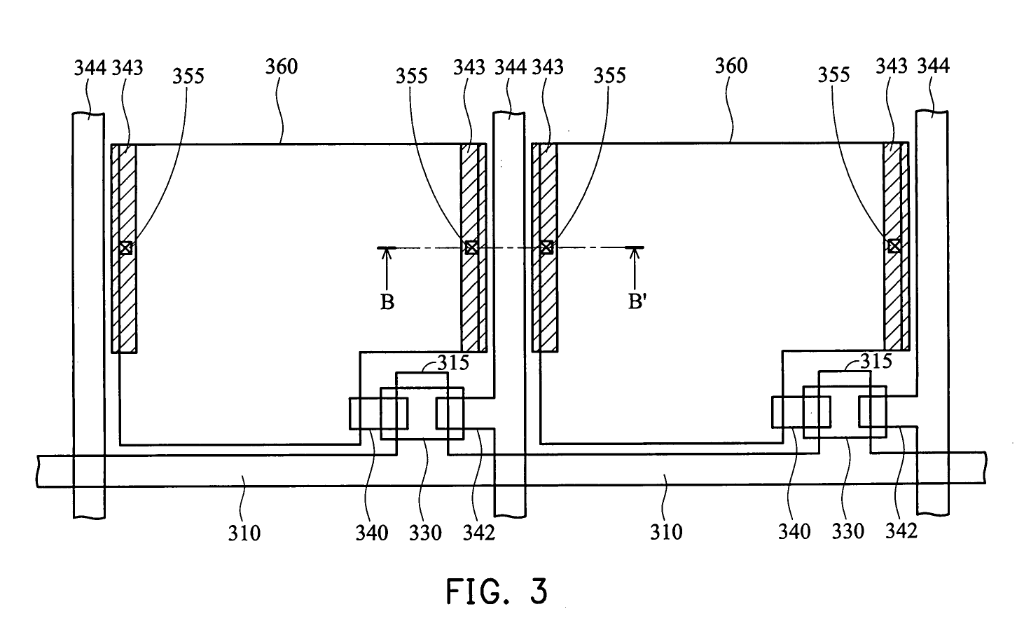

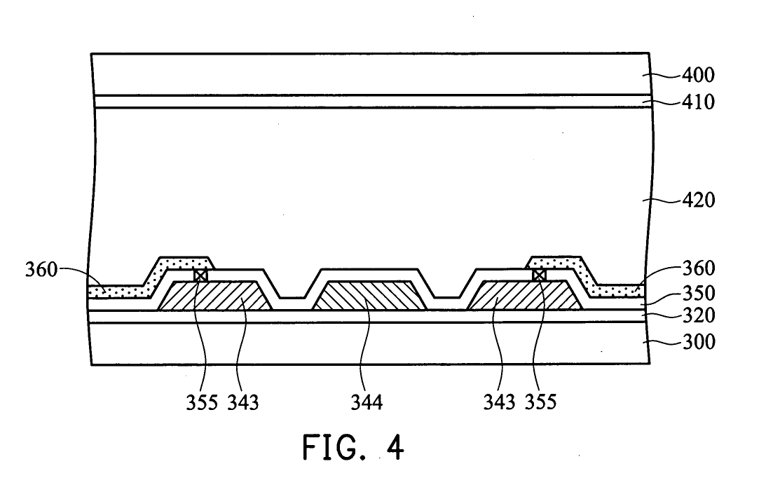

FIG. 3 is a plan view of an LCD device of the present invention. FIG. 4 is a sectional view taken along line B-B′ of FIG. 3. In order to simplify the illustration, FIG. 3 shows a substrate in two adjacent pixel regions. That is, there may be a large number of pixel regions.

In FIGS. 3 and 4, a first substrate 300 serving as a lower substrate is provided. The first substrate 300 can be a heat-resistant glass substrate. By performing a photolithography (or patterning) procedure using a first photomask (or reticle), a plurality of transversely expanding gate lines 310 are formed on the first substrate 300. The gate line 310 has a protruding portion 315 serving as a gate 315. Then, a first insulating layer 320 is formed over the first substrate 300 and the gate line 310. The first insulating layer 320 can be a silicon oxide (SiOₓ) layer.

By performing a photolithography procedure using a first photomask, a semiconductor layer 330 is then formed on part of the first insulating layer 320. The semiconductor layer 320 can be a polysilicon layer.

By performing a third photolithography procedure using a third photomask, a source electrode 340, a drain electrode 342, a plurality of metallic light shield layers 343 and a plurality of longitudinally expanding data lines 344 are formed on part of the first insulating layer 320. The semiconductor layer 330 serves as a channel layer between the source electrode 340 and the drain electrode 342. Also, the drain electrode 342 electrically connects the data line 344 and the metallic light shield layer 343 is located below both sides of the data line 344. It should be noted that the metallic light shield layers 343 and the data lines 344 are defined on the first insulating layer 320 in the same photolithography procedure, thereby solving the misalignment issue of the prior art. Due to a constant distance formed between the metallic light shield layer 343 and the data line 344 in each pixel cell by the above steps, the parasitic capacitance therebetween can be stabilized (or fixed/normalized). In addition, the metallic light shield layer 343 and the data line 344 can use the same metallic material, such as Al, Mo or a multilayer stack of the above.

In FIGS. 3 and 4, a second insulating layer 350 is then formed over the source electrode 340, the drain electrode 342, the metallic light shield layers 343 and the data lines 344. The second insulating layer 350 can be a silicon oxide (SiOₓ) layer. Further, conductive plugs 355 penetrating the second insulating layer 350 are then formed by photolithography and deposition.

In FIGS. 3 and 4, transparent conductive layers 360 are formed on part of the second insulating layer 350. The transparent conductive layers 360 serve as pixel electrodes, such as ITO (indium tin oxide) or IZO (indium zinc oxide). It should be noted that the metallic light shield layers 343 electrically connect the transparent conductive layers 360 by means of the conductive plugs 355. Accordingly, the metallic light shield layers 343 and the data lines 344 are equipotential, thereby eliminating the parasitic capacitance therebetween.

Moreover, as is known in the conventional LCD process, a second substrate 400 opposite the first substrate 300 is provided. The second substrate 400 can be a glass substrate. A common electrode 410 is formed on the inner side of the second substrate 300. The common electrode 410 can be an ITO (indium tin oxide) or IZO (indium zinc oxide) layer. In addition, a color filter (not shown) can be formed between the second substrate 400 and the common electrode 410. Then, liquid crystal material fills in the space between the two substrates 300 and 400 to form a liquid crystal layer 420. Thus, an LCD device is obtained.

The present invention provides a method of stabilizing parasitic capacitance in an LCD device. The data lines and the metallic light shield layers are defined on the first insulating layer in the same photolithography procedure. Moreover, the metallic light shield layer electrically connects the transparent conductive layer by means of the conductive plug. Thus, the present invention can solve the misalignment problem and cause the metallic light shield layer and the transparent conductive layer to be equipotential, thereby stabilizing parasitic capacitance in LCDs, improving display quality and ameliorating the disadvantages of the prior art.

While the invention has been described by way of example and in terms of the above, it is to be understood that the invention is not limited to the disclosed embodiments. Instead, it is intended to cover various modifications and similar arrangements as would be apparent to those skilled in the art. Therefore, the scope of the appended claims should be accorded the broadest interpretation so as to encompass all such modifications and similar arrangements.

1. A method of stabilizing parasitic capacitance in an LCD device, comprising the steps of:
providing a substrate;
forming a plurality of transversely expanding gate lines on the substrate;
forming a first insulating layer on the substrate and the gate lines;
performing a photolithography procedure using a photomask to form a plurality of longitudinally expanding data lines and a plurality of metallic light shield layers on part of the first insulating layer, wherein the metallic light shield layers are located on both sides of the data line;
forming a second insulating layer on the metallic light shield layers and the data lines; and
forming transparent conductive layers on part of the second insulating layer.

2. The method according to claim 1, further comprising the step of:
forming conductive plugs penetrating the second insulating layer to electrically connect the metallic light shield layers and the transparent conductive layers.

3. The method according to claim 1, wherein the substrate is a glass substrate.

4. The method according to claim 1, wherein the first insulating layer is a silicon oxide (SiOₓ) layer.

5. The method according to claim 1, wherein the second insulating layer is a silicon oxide (SiOₓ) layer.

6. The method according to claim 1, wherein the metallic light shield layers and the data lines comprise Al and/or Mo.

7. The method according to claim 1, wherein the transparent conductive layers are ITO (indium tin oxide) or IZO (indium zinc oxide) layers.

8. The method according to claim 2, wherein the metallic light shield layers and the transparent conductive layers are equipotential.

9. A method of stabilizing parasitic capacitance in an LCD device, comprising the steps of:
providing a glass substrate;
forming a plurality of transversely expanding gate lines on the glass substrate;
forming a first silicon oxide (SiOₓ) layer on the glass substrate and the gate lines;
performing a photolithography procedure using a photomask to form a plurality of longitudinally expanding data lines and a plurality of metallic light shield layers on part of the first silicon oxide layer, wherein the metallic light shield layers are located on both sides of the data line;
forming a second silicon oxide (SiOₓ) layer on the metallic light shield layers and the data lines;
forming conductive plugs penetrating the second silicon oxide layer; and
forming transparent conductive layers on part of the second silicon oxide layer, wherein the metallic light shield layers electrically connect the transparent conductive layers by means of the conductive plugs.

10. The method according to claim 9, wherein the metallic light shield layers and the data lines are equipotential.

11. The method according to claim 9, wherein the metallic light shield layers and the data lines comprise Al and/or Mo.

12. The method according to claim 9, wherein the transparent conductive layers are ITO (indium tin oxide) or IZO (indium zinc oxide) layers.
